(19) United States
(12) Patent Application Publication
(10) Pub. No.: US 2026/0255087 A1
(43) Pub. Date: Aug. 27, 2026

(54) SEMICONDUCTOR DEVICE

(71) Applicant: CANON KABUSHIKI KAISHA, Tokyo (JP)

(72) Inventors: NAOYUKI TSUBAKI, Tokyo (JP); MASATO SASAKI, Tokyo (JP)

(21) Appl. No.: 19/547,942

(22) Filed: Feb. 24, 2026

(30) Foreign Application Priority Data
Feb. 27, 2025 (JP) 2025-029980

(51) Int. Cl. H04N 25/78; H04N 23/63; H04N 25/705; H04N 25/79

(52) U.S. Cl. CPC H04N 25/78; H04N 23/632; H04N 25/705; H04N 25/79

(57) ABSTRACT

A semiconductor device includes a first signal line, a second signal line, and a transmission selection circuit connected to the first signal line and the second signal line. A first signal is input to the transmission selection circuit at a first input frequency, and a second signal is input to the transmission selection circuit at a second input frequency lower than the first input frequency. The transmission selection circuit outputs the first signal to the first signal line in a first mode and outputs the first signal to the second signal line in a second mode.

### BACKGROUND

### Field of the Technology

The present disclosure relates to a semiconductor device.

### Description of the Related Art

Japanese Patent Laid-Open No. 2009-134573 discloses a semiconductor device that tests whether an inter-chip wiring can normally perform data transfer, and when a connection failure is detected, performs data transfer at double speed via the normal inter-chip wiring. As a result, data that is to be transferred through the inter-chip wiring in which the connection failure is detected can be transmitted through the normal inter-chip wiring, and thus a decrease in the bandwidth of data transfer can be suppressed.

In the failure countermeasure described in Japanese Patent Laid-Open No. 2009-134573, there is a case where the countermeasure against the failure due to the deterioration over time is not sufficient.

### SUMMARY

The present disclosure is directed toward a semiconductor device capable of reducing the possibility of failure due to deterioration over time.

According to one aspect of the present disclosure, there is provided a semiconductor device including a first signal line, a second signal line, and a transmission selection circuit connected to the first signal line and the second signal line. A first signal is input to the transmission selection circuit at a first input frequency, and a second signal is input to the transmission selection circuit at a second input frequency lower than the first input frequency. The transmission selection circuit outputs the first signal to the first signal line in a first mode and outputs the first signal to the second signal line in a second mode.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a schematic configuration of a semiconductor device according to a first embodiment.

FIG. 2 is a circuit diagram illustrating a configuration of a transmission selection circuit according to the first embodiment.

FIG. 3 is a circuit diagram illustrating a configuration of a reception selection circuit according to the first embodiment.

FIG. 4 is a diagram illustrating an operation of the semiconductor device according to the first embodiment.

FIG. 5 is a block diagram illustrating a schematic configuration of a semiconductor device according to a second embodiment.

FIG. 6 is a circuit diagram illustrating a configuration of a transmission selection circuit according to the second embodiment.

FIG. 7 is a circuit diagram illustrating a configuration of a reception selection circuit according to the second embodiment.

FIG. 8 is a diagram illustrating an operation of the semiconductor device according to the second embodiment.

FIG. 9 is a block diagram illustrating a schematic configuration of equipment according to a third embodiment.

FIGS. 10A and 10B are block diagrams illustrating a schematic configuration of equipment according to a fourth embodiment.

### DESCRIPTION OF THE EMBODIMENTS

Hereinafter, embodiments of the present disclosure will be described with reference to the drawings. The same or corresponding elements are denoted by the same reference numerals throughout the several drawings, and the description thereof may be omitted or simplified.

### First Embodiment

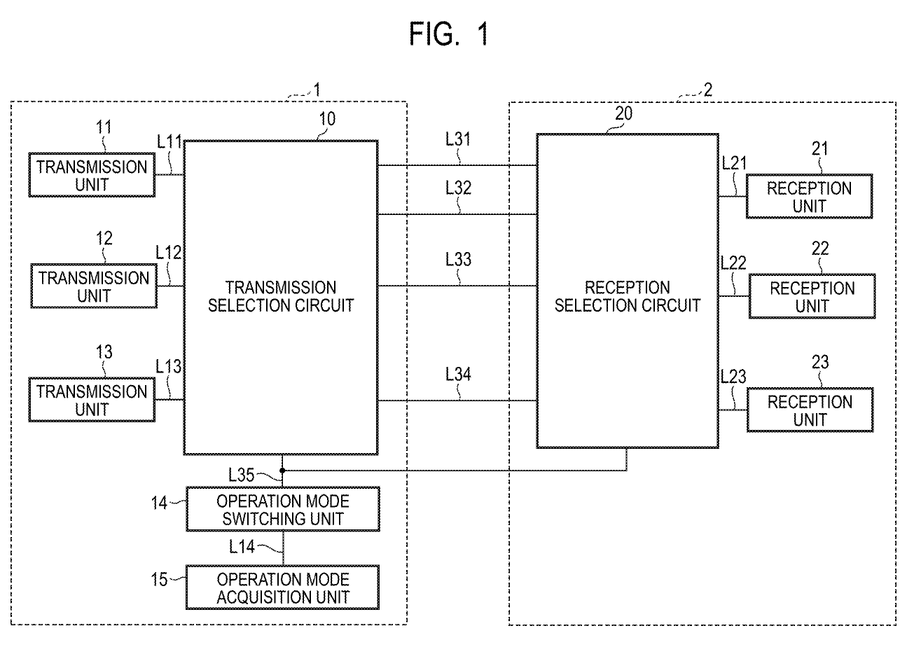

FIG. 1 is a block diagram illustrating a schematic configuration of a semiconductor device according to the present embodiment. The semiconductor device includes a first substrate 1 and a second substrate 2. Each of the first substrate 1 and the second substrate 2 is a semiconductor substrate in which semiconductor elements are formed. The first substrate 1 and the second substrate 2 are stacked so that the second substrate 2 can receive signals output from the first substrate 1.

A transmission selection circuit 10, transmission units 11, 12, and 13, an operation mode switching unit 14, and an operation mode acquisition unit 15 are arranged in the first substrate 1. The transmission unit 11 and the transmission selection circuit 10 are connected by a signal line L11, the transmission unit 12 and the transmission selection circuit 10 are connected by a signal line L12, and the transmission unit 13 and the transmission selection circuit 10 are connected by a signal line L13. The operation mode acquisition unit 15 and the operation mode switching unit 14 are connected by a signal line L14.

A reception selection circuit 20 and reception units 21, 22, and 23 are arranged in the second substrate 2. The reception unit 21 and the reception selection circuit 20 are connected by a signal line L21, the reception unit 22 and the reception selection circuit 20 are connected by a signal line L22, and the reception unit 23 and the reception selection circuit 20 are connected by a signal line L23.

A plurality of output terminals of the transmission selection circuit 10 and a plurality of input terminals of the reception selection circuit 20 are connected by signal lines L31, L32, L33, and L34. The operation mode switching unit 14, the transmission selection circuit 10, and the reception selection circuit 20 are connected to each other by a signal line L35. The signal lines L31, L32, L33, L34, and L35 are arranged across the first substrate 1 and the second substrate 2. That is, the signal lines L31, L32, L33, L34, and L35 are arranged so as to pass through a connection portion between the first substrate 1 and the second substrate 2.

The transmission unit 11 outputs a high operation rate signal (first signal) to the transmission selection circuit 10 via the signal line L11. The transmission unit 12 outputs a low operation rate signal (second signal) to the transmission selection circuit 10 via the signal line L12, and the transmission unit 13 outputs a low operation rate signal (third signal) to the transmission selection circuit 10 via the signal line L13. An input frequency (second input frequency) of the low operation rate signal from the transmission unit 12 and an input frequency (third input frequency) of the low operation rate signal from the transmission unit 13 are both lower than an input frequency (first input frequency) of the high operation rate signal from the transmission unit 11.

The high operation rate signal input to the transmission selection circuit 10 is input to the reception selection circuit 20 via either the signal line L31 (first signal line) or the signal line L32 (second signal line). The low operation rate signals input to the transmission selection circuit 10 are input to the reception selection circuit 20 via the signal line L33 (third signal line) and the signal line L34 (fourth signal line).

The reception unit 21 receives the high operation rate signal from the reception selection circuit 20 via the signal line L21. The reception unit 22 receives the low operation rate signal from the reception selection circuit 20 via the signal line L22, and the reception unit 23 receives the low operation rate signal from the reception selection circuit 20 via the signal line L23.

Specific examples of the high operation rate signal include pixel signals constituting an image. The image may be a still image or a moving image. Specific examples of the low operation rate signal include a signal for a live view and a signal for ranging. Since the signal for the live view and the signal for ranging may have a smaller amount of information or a smaller acquisition frequency than the pixel signals constituting the image, the signal for the live view and the signal for ranging may have a relatively low operation rate. The transmission units 11, 12, and 13 may have a function of acquiring these signals generated in the photoelectric conversion device and transmitting the signals to the second substrate 2. The second substrate 2 may be capable of receiving and processing these signals. The photoelectric conversion device may be arranged in the first substrate 1 or may be arranged in another substrate. In these specific examples, the semiconductor device of the present embodiment is a signal processing device that processes a signal generated by photoelectric conversion in the photoelectric conversion device, or a signal processing unit that is built in the photoelectric conversion device and processes a signal generated by photoelectric conversion in the photoelectric conversion unit.

The operation mode acquisition unit 15 acquires a control signal indicating an operation mode. When the operation mode is changed, the operation mode acquisition unit 15 outputs a control signal instructing to change a signal transmission path according to the operation mode to the operation mode switching unit 14 via the signal line L14. The operation mode switching unit 14 generates a control signal for controlling a demultiplexer and a multiplexer in the transmission selection circuit 10 and the reception selection circuit 20 based on the operation mode that has switched. The operation mode switching unit 14 outputs the control signal to the transmission selection circuit 10 and the reception selection circuit 20 via the signal line L35. Note that the control signal indicating the operation mode may be input from a control unit of equipment such as an imaging device in which the semiconductor device is mounted, may be input from a control unit in the semiconductor device, or may be input based on a user operation.

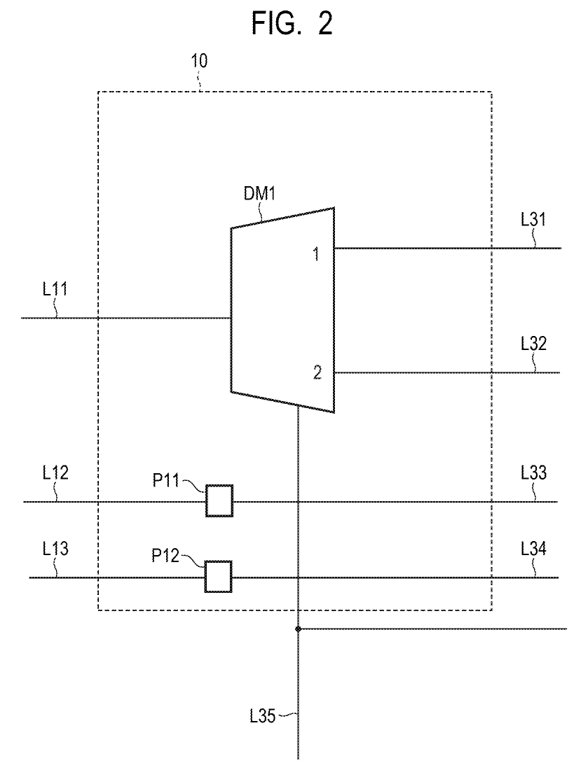

FIG. 2 is a circuit diagram illustrating a configuration of the transmission selection circuit 10 according to the present embodiment. The transmission selection circuit 10 includes a demultiplexer DM1. The demultiplexer DM1 has an input terminal, a control terminal, a first output terminal, and a second output terminal. The demultiplexer DM1 enables either the first output terminal or the second output terminal according to the control signal input to the control terminal. Terminal numbers "1" and "2" in the demultiplexer DM1 indicate the first output terminal and the second output terminal, respectively. In demultiplexers and multiplexers described later, a plurality of output terminals or a plurality of input terminals are distinguished from each other by the similar notation.

The signal line L11 is connected to the input terminal of the demultiplexer DM1. The signal line L35 is connected to the control terminal of the demultiplexer DM1. The signal line L31 is connected to the first output terminal of the demultiplexer DM1, and the signal line L32 is connected to the second output terminal of the demultiplexer DM1. The demultiplexer DM1 outputs the high operation rate signal input via the signal line L11 to either the signal line L31 or the signal line L32 in accordance with the control signal from the operation mode switching unit 14.

The signal line L12 is connected to the signal line L33 via a connection point P11, and the signal line L13 is connected to the signal line L34 via a connection point P12. Therefore, regardless of the operation mode, the low operation rate signal input via the signal line L12 is output to the signal line L33, and the low operation rate signal input via the signal line L13 is output to the signal line L34.

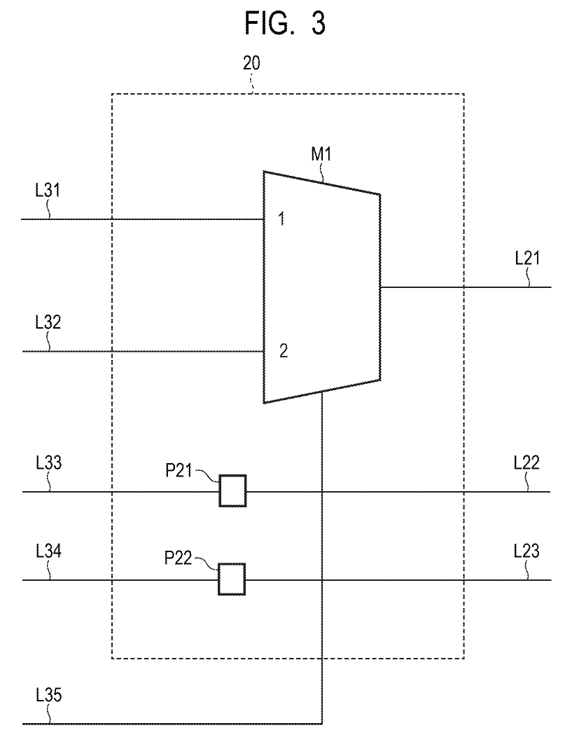

FIG. 3 is a circuit diagram illustrating a configuration of the reception selection circuit 20 according to the present embodiment. The reception selection circuit 20 includes a multiplexer M1. The multiplexer M1 has a first input terminal, a second input terminal, a control terminal, and an output terminal. The multiplexer M1 enables either the first input terminal or the second input terminal according to the control signal input to the control terminal.

The signal line L31 is connected to the first input terminal of the multiplexer M1, and the signal line L32 is connected to the second input terminal of the multiplexer M1. The signal line L35 is connected to the control terminal of the multiplexer M1. The signal line L21 is connected to the output terminal of the multiplexer M1. The multiplexer M1 outputs the high operation rate signal input via either the signal line L31 or the signal line L32 to the signal line L21 in accordance with the control signal from the operation mode switching unit 14.

The signal line L33 is connected to the signal line L22 via a connection point P21, and the signal line L34 is connected to the signal line L23 via a connection point P22. Therefore, regardless of the operation mode, the low operation rate signal input via the signal line L33 is output to the signal line L22, and the low operation rate signal input via the signal line L34 is output to the signal line L23.

As described above, the high operation rate signal output from the transmission unit 11 is input to the reception unit 21 via either the signal line L31 or the signal line L32 according to the operation mode. The low operation rate signal output from the transmission unit 12 is input to the reception unit 22 via the signal line L33 regardless of the operation mode. The low operation rate signal output from the transmission unit 13 is input to the reception unit 23 via the signal line L34 regardless of the operation mode. As described above, in the present embodiment, the two signal lines L31 and L32 transmitting the high operation rate signal are provided between the first substrate 1 and the second substrate 2, and the signal line transmitting the high operation rate signal can be switched according to the operation mode.

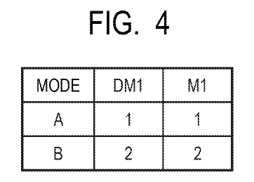

FIG. 4 is a diagram illustrating an operation of the semiconductor device according to the present embodiment. In the present embodiment, the semiconductor device operates in either a mode A (first mode) or a mode B (second mode). In FIG. 4, terminal numbers enabled in the demultiplexer DM1 and the multiplexer M1 are illustrated for each operation mode. When the operation mode acquisition unit 15 receives the control signal indicating the operation mode, the operation mode switching unit 14 controls the demultiplexer DM1 and the multiplexer M1 as illustrated in FIG. 4.

In the mode A, the first output terminal of the demultiplexer DM1 and the first input terminal of the multiplexer M1 are enabled. Thus, the demultiplexer DM1 and the multiplexer M1 are electrically connected by the signal line L31. Therefore, the high operation rate signal output from the transmission unit 11 is input to the reception unit 21 via the signal line L31.

On the other hand, in the mode B, the second output terminal of the demultiplexer DM1 and the second input terminal of the multiplexer M1 are enabled. Thus, the demultiplexer DM1 and the multiplexer M1 are electrically connected by the signal line L32. Therefore, the high operation rate signal output from the transmission unit 11 is input to the reception unit 21 via the signal line L32.

As described above, the low operation rate signals do not pass through the demultiplexer DM1 and the multiplexer M1. Therefore, in both the mode A and the mode B, the low operation rate signal output from the transmission unit 12 is input to the reception unit 22 via the signal line L33, and the low operation rate signal output from the transmission unit 13 is input to the reception unit 23 via the signal line L34.

In general, deterioration over time may occur in a signal line or a member in the vicinity of the signal lines due to a current flowing through the signal line. For example, electromigration may occur in a material forming a signal line due to a current flowing through the signal line. Alternatively, deterioration of an interlayer insulating film may occur due to a current flowing through a signal line. The degree of deterioration due to such factors may depend on the cumulative time during which the signal is transmitted to the signal line. Therefore, a signal line transmitting the high operation rate signal is more likely to deteriorate than a signal line transmitting the low operation rate signal.

Therefore, in the present embodiment, two signal lines L31 and L32 for transmitting the high operation rate signal are provided. In the mode A, the signal line L31 is used to transmit the high operation rate signal, and in the mode B, the signal line L32 is used to transmit the high operation rate signal. Since the signal lines to be used are changed by switching the operation modes, the effective operation rates of the signal lines L31 and L32 are reduced. Accordingly, the frequency of the current flowing through each of the signal lines L31 and L32 can be reduced, and the deterioration over time of the signal lines or the members in the vicinity of the signal lines due to the current flowing through the signal lines L31 and L32 can be reduced. Therefore, according to the present embodiment, a semiconductor device capable of reducing the possibility of failure due to deterioration over time is provided. Note that switching between the mode A and the mode B can be performed, for example, so as to level out the time during which the signal line L31 transmits the high operation rate signal and the time during which the signal line L32 transmits the high operation rate signal.

The signal line connecting the first substrate 1 and the second substrate 2 is a long wiring in many cases, and there is a high possibility that deterioration over time causes a failure. Therefore, in the present embodiment, a method of switching the signal line to be used according to the operation mode as described above is applied to the signal lines L31 and L32 for the high operation rate signal between the first substrate 1 and the second substrate 2. As described above, in a configuration in which a plurality of substrates are stacked, it is desirable that the above-described technique be applied to the signal lines passing through the connection portion between the substrates. However, the above-described technique may be applied to signal lines between elements arranged on one substrate.

### Second Embodiment

In the present embodiment, modifications related to the configurations of the transmission selection circuit 10 and the reception selection circuit 20, the signal lines between the substrates, the setting of the operation modes, and the like will be described. In the present embodiment, description of elements common to those of the first embodiment may be omitted or simplified.

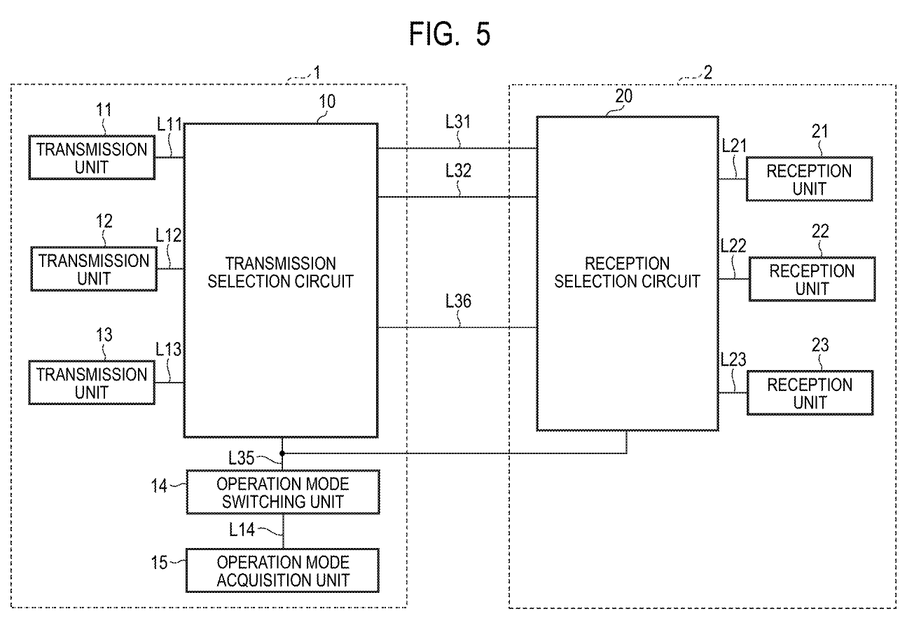

FIG. 5 is a block diagram illustrating a schematic configuration of the semiconductor device according to the present embodiment. In the present embodiment, a plurality of output terminals of the transmission selection circuit 10 and a plurality of input terminals of the reception selection circuit 20 are connected by signal lines L31, L32, and L36. That is, the signal lines L33 and L34 in the first embodiment are replaced with the signal line L36 (third signal line) in the present embodiment.

In the first embodiment, the transmission unit 11 outputs the high operation rate signal and the transmission units 12 and 13 output the low operation rate signals regardless of the operation mode, but in the present embodiment, the transmission unit that outputs the high operation rate signal is switched according to the operation mode. Since other configurations of FIG. 5 are the same as those of the first embodiment, the description thereof will be omitted.

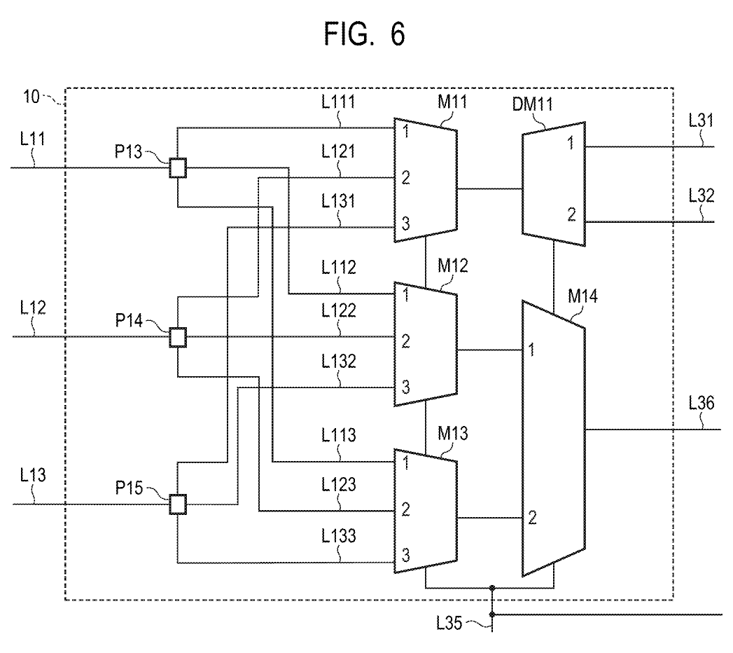

FIG. 6 is a circuit diagram illustrating a configuration of the transmission selection circuit 10 according to the present embodiment. The transmission selection circuit 10 includes a demultiplexer DM11 and multiplexers M11, M12, M13, and M14. The demultiplexer DM11 has an input terminal, a control terminal, a first output terminal, and a second output terminal. Each of the multiplexers M11, M12, and M13 has a first input terminal, a second input terminal, a third input terminal, a control terminal, and an output terminal. The multiplexer M14 has a first input terminal, a second input terminal, a control terminal, and an output terminal.

The signal line L11 is branched into signal lines L111, L112, and L113 at a branch point P13. The signal line L111 is connected to the first input terminal of the multiplexer M11, the signal line L112 is connected to the first input terminal of the multiplexer M12, and the signal line L113 is connected to the first input terminal of the multiplexer M13.

The signal line L12 is branched into signal lines L121, L122, and L123 at a branch point P14. The signal line L121 is connected to the second input terminal of the multiplexer M11, the signal line L122 is connected to the second input terminal of the multiplexer M12, and the signal line L123 is connected to the second input terminal of the multiplexer M13.

The signal line L13 is branched into signal lines L131, L132, and L133 at a branch point P15. The signal line L131 is connected to the third input terminal of the multiplexer M11, the signal line L132 is connected to the third input terminal of the multiplexer M12, and the signal line L133 is connected to the third input terminal of the multiplexer M13.

The output terminal of the multiplexer M11 is connected to the input terminal of the demultiplexer DM11. The output terminal of the multiplexer M12 is connected to the first input terminal of the multiplexer M14, and the output terminal of the multiplexer M13 is connected to the second input terminal of the multiplexer M14.

The signal line L31 is connected to the first output terminal of the demultiplexer DM11, and the signal line L32 is connected to the second output terminal of the demultiplexer DM11. The signal line L36 is connected to the output terminal of the multiplexer M14.

The signal line L35 is connected to the control terminals of the multiplexers M11, M12, M13, and M14 and the control terminal of the demultiplexer DM11. Each of the multiplexers M11, M12, and M13 enables one of the first input terminal, the second input terminal, and the third input terminal according to the control signal from the operation mode switching unit 14. The multiplexer M14 enables either the first input terminal or the second input terminal according to the control signal from the operation mode switching unit 14. The demultiplexer DM11 enables either the first output terminal or the second output terminal according to the control signal from the operation mode switching unit 14.

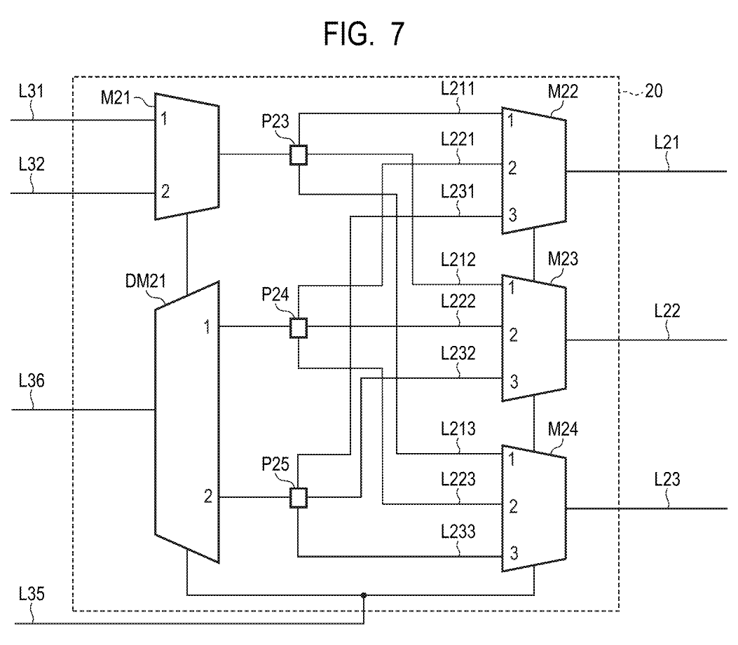

FIG. 7 is a circuit diagram illustrating a configuration of the reception selection circuit 20 according to the present embodiment. The reception selection circuit 20 includes a demultiplexer DM21 and multiplexers M21, M22, M23, and M24. The demultiplexer DM21 has an input terminal, a control terminal, a first output terminal, and a second output terminal. The multiplexer M21 has a first input terminal, a second input terminal, a control terminal, and an output terminal. Each of the multiplexers M22, M23, and M24 has a first input terminal, a second input terminal, a third input terminal, a control terminal, and an output terminal.

The signal line L31 is connected to the first input terminal of the multiplexer M21, and the signal line L32 is connected to the second input terminal of the multiplexer M21. The signal line L36 is connected to the input terminal of the demultiplexer DM21.

A signal line of the output terminal of the multiplexer M21 is branched into signal lines L211, L212, and L213 at a branch point P23. The signal line L211 is connected to the first input terminal of the multiplexer M22, the signal line L212 is connected to the first input terminal of the multiplexer M23, and the signal line L213 is connected to the first input terminal of the multiplexer M24.

A signal line of the first output terminal of the demultiplexer DM21 is branched into signal lines L221, L222, and L223 at a branch point P24. The signal line L221 is connected to the second input terminal of the multiplexer M22, the signal line L222 is connected to the second input terminal of the multiplexer M23, and the signal line L223 is connected to the second input terminal of the multiplexer M24.

The signal line of the second output terminal of the demultiplexer DM21 is branched into signal lines L231, L232, and L233 at a branch point P25. The signal line L231 is connected to the third input terminal of the multiplexer M22, the signal line L232 is connected to the third input terminal of the multiplexer M23, and the signal line L233 is connected to the third input terminal of the multiplexer M24.

The signal line L21 is connected to the output terminal of the multiplexer M22, the signal line L22 is connected to the output terminal of the multiplexer M23, and the signal line L23 is connected to the output terminal of the multiplexer M24.

The signal line L35 is connected to the control terminals of the multiplexers M21, M22, M23, and M24 and the control terminal of the demultiplexer DM21. The multiplexer M21 enables either the first input terminal or the second input terminal according to the control signal from the operation mode switching unit 14. Each of the multiplexers M22, M23, and M24 enables one of the first input terminal, the second input terminal, and the third input terminal according to the control signal from the operation mode switching unit 14. The demultiplexer DM21 enables either the first output terminal or the second output terminal according to the control signal from the operation mode switching unit 14.

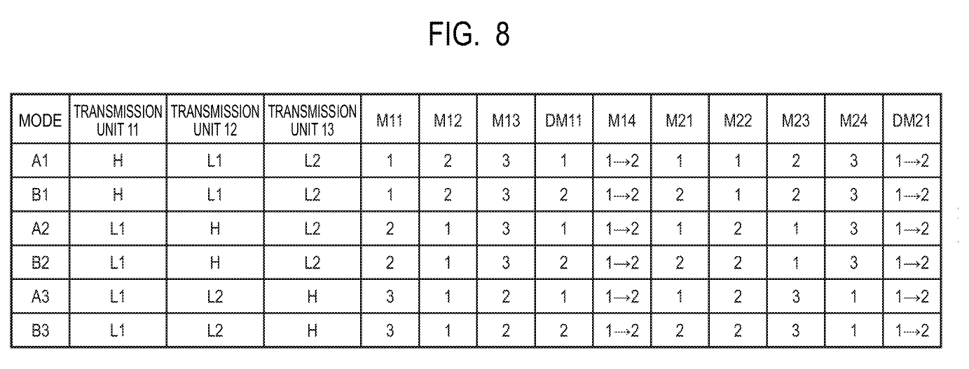

FIG. 8 is a diagram illustrating an operation of the semiconductor device according to the present embodiment. In the present embodiment, the semiconductor device operates in any of a mode A1, a mode B1, a mode A2, a mode B2, a mode A3, and a mode B3.

In the present embodiment, one transmission unit of the three transmission units outputs the high operation rate signal H in accordance with the operation mode. Further, in the present embodiment, two transmission units of the three transmission units respectively output two types of low operation rate signals L1 and L2 according to the operation mode. Furthermore, in the present embodiment, the low operation rate signals L1 and L2 are output in a time-division manner. It is assumed that the low operation rate signal L1 is output and the low operation rate signal L2 is not output in the former half of one transmission period. In addition, it is assumed that the low operation rate signal L2 is output and the low operation rate signal L1 is not output in the latter half of one transmission period. FIG. 8 illustrates, for each operation mode, which of the high operation rate signal H, the low operation rate signal L1, and the low operation rate signal L2 each of the transmission unit 11, the transmission unit 12, and the transmission unit 13 outputs. The time at which the operation is switched between the former half and the latter half of one transmission period can be measured by a timer in the operation mode switching unit 14.

In FIG. 8, terminal numbers enabled in the multiplexers M11, M12, M13, M14, M21, M22, M23, and M24 and the demultiplexers DM11 and DM21 are illustrated for

each operation mode. When the operation mode acquisition unit 15 receives the control signal indicating the operation mode, the operation mode switching unit 14 controls the multiplexers M11, M12, M13, M14, M21, M22, M23, and M24 and the demultiplexers DM11 and DM21 as illustrated in FIG. 8. In FIG. 8, "1→2" indicates that the first input terminal or the first output terminal is enabled in the former half of one transmission period, and the second input terminal or the second output terminal is enabled in the latter half of one transmission period.

First, the case of the mode A1 will be described. In the mode A1, the transmission unit 11 outputs the high operation rate signal H, the transmission unit 12 outputs the low operation rate signal L1 in the former half of one transmission period, and the transmission unit 13 outputs the low operation rate signal L2 in the latter half of one transmission period.

As illustrated in FIG. 8, the first input terminal of the multiplexer M11, the first output terminal of the demultiplexer DM11, the first input terminal of the multiplexer M21, and the first input terminal of the multiplexer M22 are enabled. Accordingly, the high operation rate signal H output from the transmission unit 11 is input to the reception unit 21 via the signal lines L11, L111, L31, L211, and L21.

As illustrated in FIG. 8, the second input terminal of the multiplexer M12, the third input terminal of the multiplexer M13, the second input terminal of the multiplexer M23, and the third input terminal of the multiplexer M24 are enabled. The first input terminal of the multiplexer M14 and the first output terminal of the demultiplexer DM21 are enabled in the former half of one transmission period, and the second input terminal of the multiplexer M14 and the second output terminal of the demultiplexer DM21 are enabled in the latter half of one transmission period. Accordingly, the low operation rate signal L1 output from the transmission unit 12 in the former half of one transmission period is input to the reception unit 22 via the signal lines L12, L122, L36, L222, and L22. The low operation rate signal L2 output from the transmission unit 13 in the latter half of one transmission period is input to the reception unit 23 via the signal lines L13, L133, L36, L233, and L23.

Next, the case of the mode B1 will be described. In the mode B1, the signals output from the transmission units 11, 12, and 13 are the same as those in the mode A1. In the mode B1, the paths of the low operation rate signals L1 and L2 are the same as those in the mode A1. Description thereof will be omitted.

The mode B1 is different from the mode A1 in that the second output terminal of the demultiplexer DM11 and the second input terminal of the multiplexer M21 are enabled. Accordingly, the high operation rate signal H output from the transmission unit 11 is input to the reception unit 21 via the signal lines L11, L111, L32, L211, and L21.

Next, the case of the mode A2 will be described. In the mode A2, the transmission unit 11 outputs the low operation rate signal L1 in the former half of one transmission period, the transmission unit 12 outputs the high operation rate signal H, and the transmission unit 13 outputs the low operation rate signal L2 in the latter half of one transmission period.

As illustrated in FIG. 8, the second input terminal of the multiplexer M11, the first output terminal of the demultiplexer DM11, the first input terminal of the multiplexer M21, and the first input terminal of the multiplexer M23 are enabled. Accordingly, the high operation rate signal H output from the transmission unit 12 is input to the reception unit 22 via the signal lines L12, L121, L31, L212, and L22.

As illustrated in FIG. 8, the first input terminal of the multiplexer M12, the third input terminal of the multiplexer M13, the second input terminal of the multiplexer M22, and the third input terminal of the multiplexer M24 are enabled. The first input terminal of the multiplexer M14 and the first output terminal of the demultiplexer DM21 are enabled in the former half of the transmission period, and the second input terminal of the multiplexer M14 and the second output terminal of the demultiplexer DM21 are enabled in the latter half of one transmission period. Accordingly, the low operation rate signal L1 output from the transmission unit 11 in the former half of one transmission period is input to the reception unit 21 via the signal lines L11, L112, L36, L221, and L21. The low operation rate signal L2 output from the transmission unit 13 in the latter half of one transmission period is input to the reception unit 23 via the signal lines L13, L133, L36, L233, and L23.

Next, the case of the mode B2 will be described. In the mode B2, the signals output from the transmission units 11, 12, and 13 are the same as those in the mode A2. In the mode B2, the paths of the low operation rate signals L1 and L2 are the same as those in the mode A2. Description thereof will be omitted.

The mode B2 is different from the mode A2 in that the second output terminal of the demultiplexer DM11 and the second input terminal of the multiplexer M21 are enabled. Accordingly, the high operation rate signal H output from the transmission unit 12 is input to the reception unit 22 via the signal lines L12, L121, L32, L212, and L22.

Next, the case of the mode A3 will be described. In the mode A3, the transmission unit 11 outputs the low operation rate signal L1 in the former half of one transmission period, the transmission unit 12 outputs the low operation rate signal L2 in the latter half of one transmission period, and the transmission unit 13 outputs the high operation rate signal H.

As illustrated in FIG. 8, the third input terminal of the multiplexer M11, the first output terminal of the demultiplexer DM11, the first input terminal of the multiplexer M21, and the first input terminal of the multiplexer M24 are enabled. Accordingly, the high operation rate signal H output from the transmission unit 13 is input to the reception unit 23 via the signal lines L13, L131, L31, L213, and L23.

As illustrated in FIG. 8, the first input terminal of the multiplexer M12, the second input terminal of the multiplexer M13, the second input terminal of the multiplexer M22, and the third input terminal of the multiplexer M23 are enabled. The first input terminal of the multiplexer M14 and the first output terminal of the demultiplexer DM21 are enabled in the former half of one transmission period, and the second input terminal of the multiplexer M14 and the second output terminal of the demultiplexer DM21 are enabled in the latter half of one transmission period. Accordingly, the low operation rate signal L1 output from the transmission unit 11 in the former half of one transmission period is input to the reception unit 21 via the signal lines L11, L112, L36, L221, and L21. The low operation rate signal L2 output from the transmission unit 12 in the latter half of one transmission period is input to the reception unit 22 via the signal lines L12, L123, L36, L232, and L22.

Next, the case of the mode B3 will be described. In the mode B3, the signals output from the transmission units 11, 12, and 13 are the same as those in the mode A3. In the mode B3, the paths of the low operation rate signals L1 and L2 are the same as those in the mode A3. Description thereof will be omitted.

The mode B3 is different from the mode A3 in that the second output terminal of the demultiplexer DM11 and the second input terminal of the multiplexer M21 are enabled. Accordingly, the high operation rate signal H output from the transmission unit 13 is input to the reception unit 23 via the signal lines L13, L131, L32, L213, and L23.

As in the first embodiment, also in the present embodiment, the signal line L31 is used for a signal of the high operation rate signal in the modes A1, A2, and A3 (first modes), and the signal line L32 is used for a signal of the high operation rate signal in the modes B1, B2, and B3 (second modes). Therefore, as in the first embodiment, also in the present embodiment, a semiconductor device capable of reducing the possibility of failure due to deterioration over time is provided.

In addition, in the present embodiment, in the modes A1, A2, and A3, the assignment of the transmission unit that outputs the high operation rate signal H and the transmission units that output the low operation rate signals L1 and L2 among the three transmission units 11, 12, and 13 is switched. The same applies to the modes B1, B2, and B3. In other words, in the present embodiment, the input terminal of the transmission selection circuit 10 to which each of the high operation rate signal H and the low operation rate signals L1 and L2 is input changes according to the mode. In the present embodiment, even when the operation rate of the input signal changes due to the switching of the operation mode as described above, it is possible to output the signal to an appropriate signal line by appropriately switching the enabled terminals of the multiplexers and the demultiplexers. Thus, in the present embodiment, a semiconductor device capable of supporting transmission of a signal whose input frequency changes according to an operation mode is provided.

In the present embodiment, the low operation rate signal L1 flows through the signal line L36 in the former half of one transmission period, and the low operation rate signal L2 flows through the signal line L36 in the latter half of one transmission period. Accordingly, it is possible to perform an operation in which a plurality of signals having a low operation rate flow through one signal line L36 in a time-division manner. Accordingly, since the number of signal lines can be reduced with respect to the configuration in which two signal lines are provided for the low operation rate signal as in the first embodiment, the area occupied by the wirings can be reduced.

### Third Embodiment

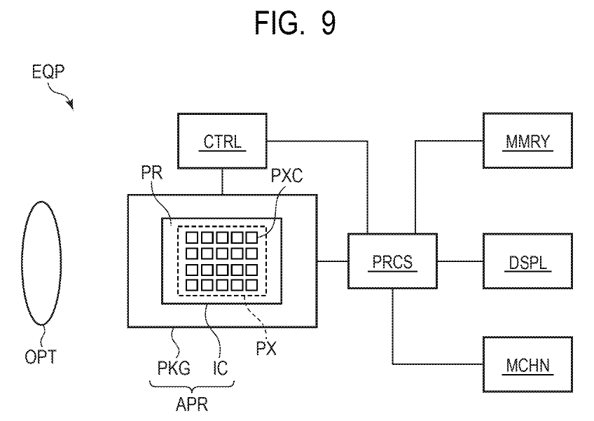

Equipment according to a third embodiment will be described with reference to FIG. 9. FIG. 9 is a block diagram illustrating a schematic configuration of equipment according to the present embodiment.

FIG. 9 is a schematic diagram illustrating equipment EQP including a photoelectric conversion device APR. All or part of the photoelectric conversion device

APR is a semiconductor device IC. The semiconductor device IC has the function of the semiconductor device according to the present disclosure. The photoelectric conversion device APR of this example can be used as, for example, an image sensor, an auto focus (AF) sensor, a photometric sensor, a ranging sensor, or the like. The semiconductor device IC has a pixel area PX in which pixel circuits PXC each including photoelectric conversion unit are arranged in a matrix. The semiconductor device IC may have a peripheral area PR around the pixel area PX. Circuits other than the pixel circuits can be arranged in the peripheral area PR.

The photoelectric conversion device APR may have a structure (stacked chips structure) in which a first semiconductor chip provided with a plurality of photoelectric conversion units and a second semiconductor chip provided with a peripheral circuit are stacked. Each of the peripheral circuits in the second semiconductor chip may be a column circuit corresponding to a pixel column of the first semiconductor chip. Each of the peripheral circuits in the second semiconductor chip may be a matrix circuit corresponding to a pixel or a pixel block in the first semiconductor chip. For the connection between the first semiconductor chip and the second semiconductor chip, a through electrode (TSV), an inter-chip wiring by direct bonding of a conductor such as copper, a connection by a micro bump between chips, a connection by wire bonding, or the like can be employed.

The photoelectric conversion device APR may include a package PKG for mounting the semiconductor device IC in addition to the semiconductor device IC. The package PKG may include a base body to which the semiconductor device IC is fixed, a lid such as glass facing the semiconductor device IC, and a connection member such as a bonding wire or a bump for connecting a terminal provided on the base body and a terminal provided on the semiconductor device IC.

The equipment EQP may further include at least one of an optical device OPT, a control device CTRL, a processing device PRCS, a display device DSPL, a storage device MMRY, and a mechanical device MCHN. The optical device OPT corresponds to the photoelectric conversion device APR, and is, for example, a lens, a shutter, or a mirror. The control device CTRL controls the photoelectric conversion device APR, and is, for example, a semiconductor device such as an ASIC.

The processing device PRCS processes a signal output from the photoelectric conversion device APR, and constitutes an analog front end (AFE) or a digital front end (DFE). The processing device PRCS is a semiconductor device such as a central processing unit (CPU) or an application specific integrated circuit (ASIC). The display device DSPL is an EL display device, a liquid crystal display device, or the like that displays information (image) obtained by the photoelectric conversion device APR. The storage device MMRY is a magnetic device, a semiconductor device, or the like that stores information (image) obtained by the photoelectric conversion device APR. The storage device MMRY is a volatile memory such as an SRAM or a DRAM, or a nonvolatile memory such as a flash memory or a hard disk drive.

The mechanical device MCHN includes a movable portion or a propulsion portion such as a motor or an engine. In the equipment EQP, a signal output from the photoelectric conversion device APR is displayed on the display device DSPL or transmitted to the outside by a communication device (not illustrated) included in the equipment EQP. Therefore, the equipment EQP may further include a storage device MMRY and a processing device PRCS separately from the storage circuit unit and the arithmetic circuit unit included in the photoelectric conversion device APR. The mechanical device MCHN may be controlled based on a signal output from the photoelectric conversion device APR.

The equipment EQP illustrated in FIG. 9 may be an electronic device such as an information terminal (for example, a smartphone and a wearable terminal) having a photographing function, a camera (for example, an interchangeable lens camera, a compact camera, a video camera, and a surveillance camera), or the like. The mechanical device MCHN in the camera may drive parts of the optical device OPT for zooming, focusing, and shutter operation. Also, the equipment EQP may be a transport device (movable body) such as a vehicle, a ship, a drone, or an airplane. The equipment EQP may be a medical device such as an endoscope or a CT scanner. The equipment EQP may be a measurement device such as a ranging sensor, an analysis device such as an electron microscope, an office device such as a copier, or an industrial device such as a robot.

The mechanical device MCHN in the transport device may be used as a movable device. The equipment EQP as a transport device is suitable for transporting the photoelectric conversion device APR, or for assisting and/or automating driving (manipulation) by an imaging function. The processing device PRCS for assisting and/or automating driving (manipulation) may perform processing for operating the mechanical device MCHN as a movable device based on information obtained by the photoelectric conversion device APR.

According to the present disclosure, there is provided a semiconductor device capable of reducing the possibility of failure due to deterioration over time. Therefore, the photoelectric conversion device APR according to the present embodiment may provide a high value to a designer, a manufacturer, a seller, a purchaser, and/or a user thereof. Therefore, when the photoelectric conversion device APR is mounted on the equipment EQP, the value of the equipment EQP may also be increased. Therefore, in manufacturing and selling the equipment EQP, it is advantageous to determine the mounting of the photoelectric conversion device APR of the present embodiment on the equipment EQP in order to increase the value of the equipment EQP. Here, increasing the value corresponds to at least one of adding a function, improving performance, improving characteristics, improving reliability, improving manufacturing yield, reducing environmental load, reducing cost, reducing size, and reducing weight.

For example, by mounting the photoelectric conversion device APR in a transport device, it is possible to obtain excellent performance when photographing outside the transport device or measuring an external environment. Therefore, in manufacturing and selling the transport device, it is advantageous to determine the mounting of the photoelectric conversion device APR according to the present embodiment on the transport device in order to improve the performance of the transport device itself. In particular, the photoelectric conversion device APR is suitable for a transport device that performs driving support and/or automatic driving of the transport device using information obtained by the photoelectric conversion device APR.

### Fourth Embodiment

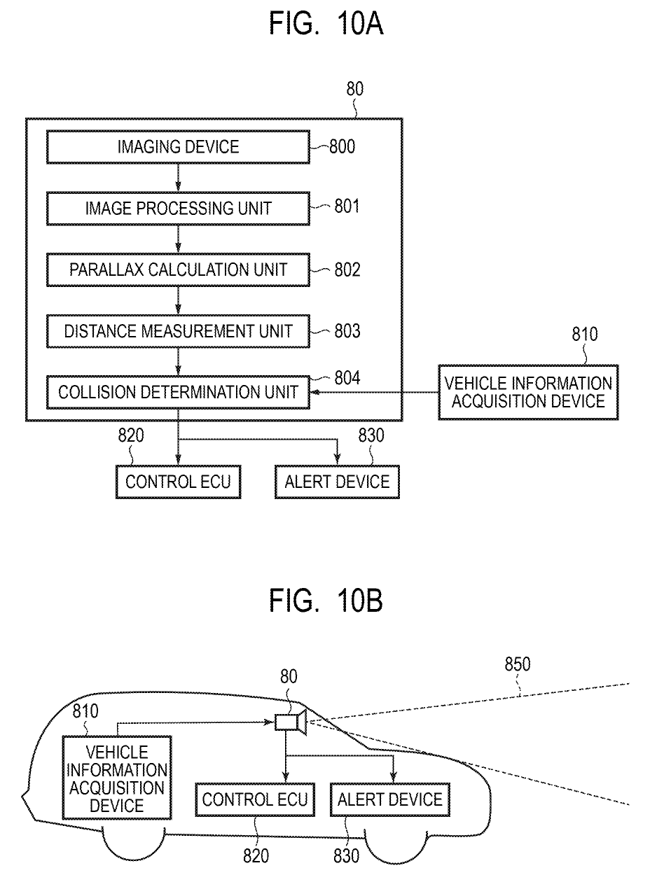

FIGS. 10A and 10B are block diagrams of equipment relating to the vehicle-mounted camera according to the present embodiment. FIGS. 10A and 10B illustrate an example in which the above-described photoelectric conversion device including the semiconductor device according to the present disclosure is applied to a movable body such as a vehicle. The equipment 80 includes an imaging device 800 (an example of the photoelectric conversion device) and a signal processing device (processing device) that processes a signal from the imaging device 800. The equipment 80 includes an image processing unit 801 that performs image processing on a plurality of pieces of image data acquired by the imaging device 800, and a parallax calculation unit 802 that calculates parallax (phase difference of parallax images) from the plurality of pieces of image data acquired by the equipment 80.

Here, the equipment 80 may include an optical system (not illustrated) that guides light to the imaging device 800. The optical system may include, for example, a lens, a shutter, and a mirror. A plurality of photoelectric conversion units substantially conjugate to the pupil of the optical system may be arranged in a pixel included in the imaging device 800. For example, a plurality of photoelectric conversion units are arranged corresponding to one microlens. The plurality of photoelectric conversion units may receive light fluxes transmitted through different positions of the pupil of the optical system. Thus, the imaging device 800 outputs a plurality of pieces of image data respectively corresponding to the light fluxes transmitted through different positions of the pupil of the optical system. Then, the parallax calculation unit 802 may calculate the parallax using the plurality of pieces of image data being output.

The equipment 80 includes a distance measurement unit 803 that calculates a distance to an object based on the calculated parallax, and a collision determination unit 804 that determines whether or not there is a possibility of collision based on the calculated distance. Here, the parallax calculation unit 802 and the distance measurement unit 803 are examples of a distance information acquisition unit that acquires distance information to the object. That is, the distance information is information on a parallax, a defocus amount, a distance to the object, and the like. The collision determination unit 804 may determine the possibility of collision using any of these pieces of distance information. Note that the distance information may be acquired using a time of flight (ToF) technique. The distance information acquisition unit may be realized by dedicatedly designed hardware or software modules. Further, it may be realized by a field programmable gate array (FPGA), an application specific integrated circuit (ASIC) or a combination thereof.

The equipment 80 is connected to the vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm such as a sound, displaying alert information on a screen of a car navigation system or the like, or giving vibration to a seat belt or a steering wheel. The equipment 80 functions as a control unit that controls the operation of controlling the vehicle as described above.

In the present embodiment, an image of the periphery of the vehicle, for example, the front or the rear is captured by the equipment 80. FIG. 10B illustrates equipment in a case where an image is captured in front of the vehicle (image capturing range 850). The vehicle information acquisition device 810 as the imaging control unit sends an instruction to the equipment 80 or the imaging device 800 to perform the imaging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Other Embodiments

The present disclosure is not limited to the above embodiments, and various modifications are possible. For example, an example in which some of the configurations of any one of the embodiments are added to other embodiments or an example in which some of the configurations of any one of the embodiments are replaced with some of the configurations of other embodiments are also embodiments of the present disclosure.

The embodiments described above can be appropriately modified without departing from the technical idea. Note that the disclosure of the present specification includes not only the matters described in the present specification but also all matters that can be grasped from the present specification and the drawings attached to the present specification. Also, the disclosure of the present specification includes a complementary set of the concepts described in the present specification. In other words, for example, when there is a description of "A is greater than B" in the present specification, it can be said that the description of "A is not greater than B" is disclosed in the present specification even when the description of "A is not greater than B" is omitted. This is because it is assumed that the case where "A is not greater than B" is considered when "A is greater than B" is described.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that the above-described embodiments are merely specific examples for carrying out the present disclosure, and the technical scope of the present disclosure should not be interpreted in a limited manner by these embodiments. That is, the present disclosure can be implemented in various forms without departing from the technical idea or the main features thereof.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-029980, filed February 27, 2025, which is hereby incorporated by reference herein in its entirety.

What is claimed is:

1. A semiconductor device comprising:
a first signal line;
a second signal line; and
a transmission selection circuit connected to the first signal line and the second signal line,
wherein a first signal is input to the transmission selection circuit at a first input frequency, and a second signal is input to the transmission selection circuit at a second input frequency lower than the first input frequency, and
wherein the transmission selection circuit outputs the first signal to the first signal line in a first mode and outputs the first signal to the second signal line in a second mode.

2. The semiconductor device according to claim 1 further comprising a third signal line,
wherein a third signal is further input to the transmission selection circuit at a third input frequency lower than the first input frequency, and
wherein the transmission selection circuit outputs the second signal and the third signal to the third signal line in at least one of the first mode and the second mode.

3. The semiconductor device according to claim 2, wherein the transmission selection circuit outputs the second signal and the third signal to the third signal line in both the first mode and the second mode.

4. The semiconductor device according to claim 2, wherein the transmission selection circuit outputs the second signal and the third signal to the third signal line in a time-division manner.

5. The semiconductor device according to claim 2,
wherein the transmission selection circuit has a first input terminal, a second input terminal, and a third input terminal,
wherein any of the first signal, the second signal, and the third signal is input to each of the first input terminal, the second input terminal, and the third input terminal, and
wherein the transmission selection circuit is capable of outputting the first signal to the first signal line or the second signal line even when the first signal is input to any of the first input terminal, the second input terminal, and the third input terminal.

6. The semiconductor device according to claim 5, wherein the transmission selection circuit is capable of outputting the second signal or the third signal to the third signal line even when the second signal or the third signal is input to any of the first input terminal, the second input terminal, and the third input terminal.

7. The semiconductor device according to claim 1 further comprising a third signal line and a fourth signal line,
wherein a third signal is further input to the transmission selection circuit at a third input frequency lower than the first input frequency, and
wherein the transmission selection circuit outputs the second signal to the third signal line and outputs the third signal to the fourth signal line in at least one of the first mode and the second mode.

8. The semiconductor device according to claim 7, wherein the transmission selection circuit outputs the second signal to the third signal line and outputs the third signal to the fourth signal line in both the first mode and the second mode.

9. The semiconductor device according to claim 1,
wherein the transmission selection circuit includes a demultiplexer having two output terminals, and
wherein the two output terminals are connected to the first signal line and the second signal line, respectively.

10. The semiconductor device according to claim 1 further comprising a reception selection circuit connected to the first signal line and the second signal line,
wherein the reception selection circuit receives the first signal from the first signal line in the first mode and receives the first signal from the second signal line in the second mode.

11. The semiconductor device according to claim 10,
wherein the reception selection circuit includes a multiplexer having two input terminals, and
wherein the two input terminals are connected to the first signal line and the second signal line, respectively.

12. The semiconductor device according to claim 10,
wherein the transmission selection circuit is arranged in a first substrate, and
wherein the reception selection circuit is arranged in a second substrate.

13. The semiconductor device according to claim 12,
wherein the first substrate and the second substrate are stacked, and
wherein the first signal line and the second signal line pass through a connection portion between the first substrate and the second substrate.

14. The semiconductor device according to claim 1, wherein the first mode and the second mode are switched such that a time during which the first signal flows through the first signal line and a time during which the first signal flows through the second signal line are leveled out.

15. The semiconductor device according to claim 1, wherein the first signal and the second signal are generated by photoelectric conversion.

16. The semiconductor device according to claim 1, wherein the first signal includes a pixel signal constituting an image.

17. The semiconductor device according to claim 1, wherein the second signal includes a signal for a live view.

18. The semiconductor device according to claim 1, wherein the second signal includes a signal for ranging.

19. Equipment comprising:
a photoelectric conversion device including the semiconductor device according to claim 1; and
at least any one of:
an optical device adapted for the photoelectric conversion device,
a control device configured to control the photoelectric conversion device,
a processing device configured to process a signal output from the photoelectric conversion device,
a display device configured to display information obtained by the photoelectric conversion device,
a storage device configured to store information obtained by the photoelectric conversion device, and
a mechanical device configured to operate based on information obtained by the photoelectric conversion device.

20. The equipment according to claim 19, wherein the processing device acquires distance information from the photoelectric conversion device to an object.
